(19) United States
(12) Patent Application Publication
(10) Pub. No.: US 2013/0008185 A1
(43) Pub. Date: Jan. 10, 2013

(54) CRYOGEN CYLINDER

(76) Inventors: Michael D. NEWMAN, Hillsborough, NJ (US); Stephen A. McCORMICK, Warrington, PA (US)

(21) Appl. No.: 13/177,601

(22) Filed: Jul. 7, 2011

(51) Int. Cl. F17C 7/04; F17C 3/02

(52) U.S. Cl. 62/48.1; 62/45.1

(57) ABSTRACT

A cryogen cylinder includes a tank having a side wall defining a chamber for containing a cryogenic substance in the tank; and a plate assembly mounted in the chamber, the plate assembly constructed and arranged to provide a passageway for vapor from the cryogenic substance to be introduced into the passageway.

### BACKGROUND

The present embodiment relates to heat transfer cryogen storage for refrigerating spaces such as for example spaces that are in transit.

In transit refrigeration (ITR) systems are known and may include cryogenic ITR systems which use fin tube heat exchangers for liquid nitrogen and carbon dioxide chilled or frozen applications, or a snow bunker for solid CO₂ snow (or dry ice) chilled or frozen applications. Such known systems experience problems of safety, temperature control, cool down rates, dual temperature zone control, efficiency and fouling. For example, fins of a fin tube heat exchanger must be used in conjunction with a defrost cycle and related components in order to defrost frozen condensate which accumulates on the fins. Such defrost cycle requires downtime of the heat exchanger and therefore additional cost to such system, which is undesirable.

### BRIEF DESCRIPTION OF THE DRAWINGS

For a more complete understanding of the present embodiment, reference may be had to the following drawing figures taken in conjunction with the description of the embodiment, of which:

FIG. 1 shows a side cross-section view of a cryogen cylinder embodiment for use to chill or freeze products such as food products for example;

FIG. 2 shows an end view of the embodiment of FIG. 1 taken along line 2-2 in FIG. 1;

FIG. 3 shows a top plan view of the embodiment of FIG. 1 taken along line 3-3 in FIG. 1; and

FIG. 4 shows a top perspective isometric view of the embodiment in FIG. 1.

### DETAILED DESCRIPTION OF THE INVENTION

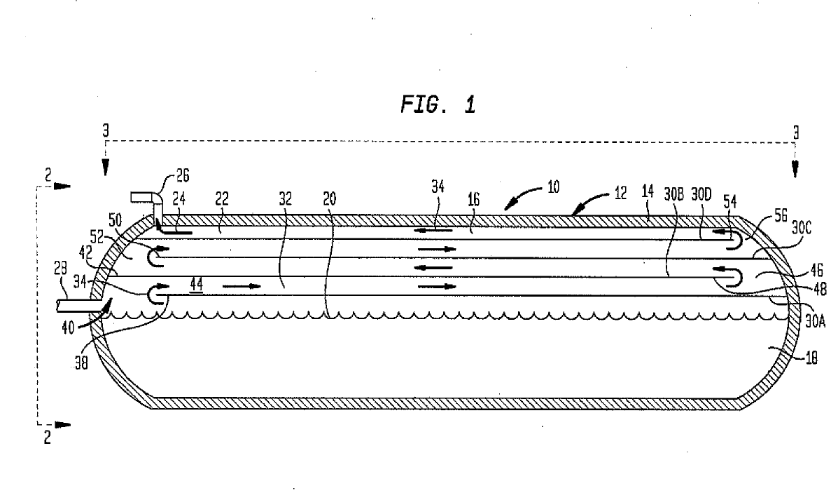

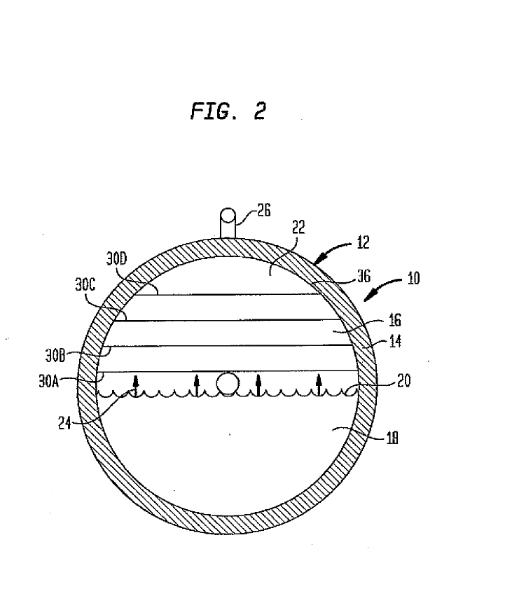

Referring to FIGS. 1-4, a cryogen cylinder of the present embodiment is shown generally at 10 and includes a tank 12 or pressure vessel having a side wall 14 which may be insulated. Such insulation is disposed substantially across the entire sidewall 14 and may be vacuum jacketed or formed of foam or polystyrene material. The side wall 14 defines a compartment having a space 16 therein for holding a cryogenic substance of either liquid nitrogen (N₂) or liquid carbon dioxide (CO₂) shown generally at 18. A surface of the liquid cryogen 18 is shown generally at 20. The liquid cryogen 18 will inevitably boil off as explained below and therefore, vapor 24 resulting from boil off of the liquid cryogen is exhausted from an atmosphere 22 above the surface 20 of the liquid cryogen 18 through a vent pipe 26 or outlet which vents the cryogen vapor to atmosphere external to the tank 12. An inlet pipe 28 or inlet is provided above the surface 20 at one end of the tank 12 to replenish the liquid cryogen 18 in the space 16.

The tank 12 can be mounted or disposed for use with ITR systems. By way of example, the tank 12 may have dimensions of 1-3 meters in length with a volume of 300-1000 liters, although a tank having other volumes may be used.

The tank 12 includes a labyrinth or alternating passageway formed by a plate assembly which can include at least one plate or alternatively a plurality of plates 30A-30D arranged in the space 16 above the surface 20 of the liquid cryogen 18. The plates 30A-30D may be manufactured from stainless steel. The construction and arrangement of the plates 30A-30D provides a continuous alternating or sinuous passageway 32 such that the cryogen vapor 24 from the liquid cryogen 18 is directed along the passageway 32 provided by the plates 30A-30D and guided upward in a flow as indicated generally by arrows 34 proceeding along the passageway to the vent pipe 26.

The plates 30A-30D do not contact the liquid cryogen 18, but instead are disposed in the atmosphere 22 of the space 16 above the surface 20 of the liquid cryogen. The plurality of plates 30A-30D create the passageway 32 to provide for increased residence time of the cryogen vapor 24 in the passageway to provide for the necessary chilling.

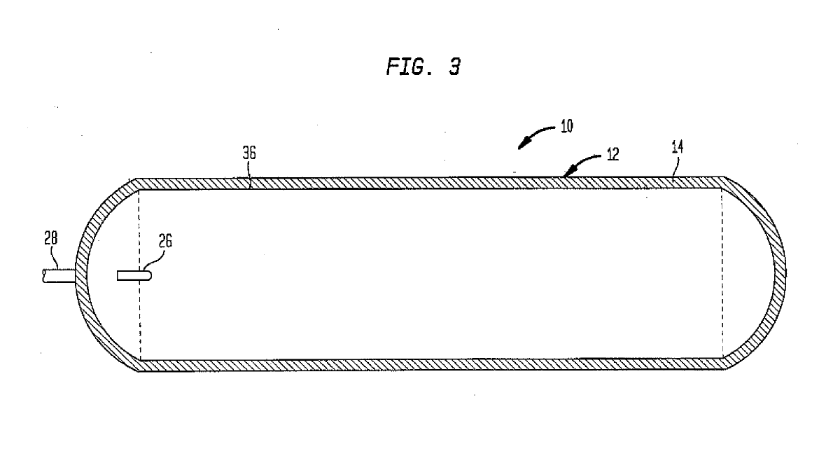

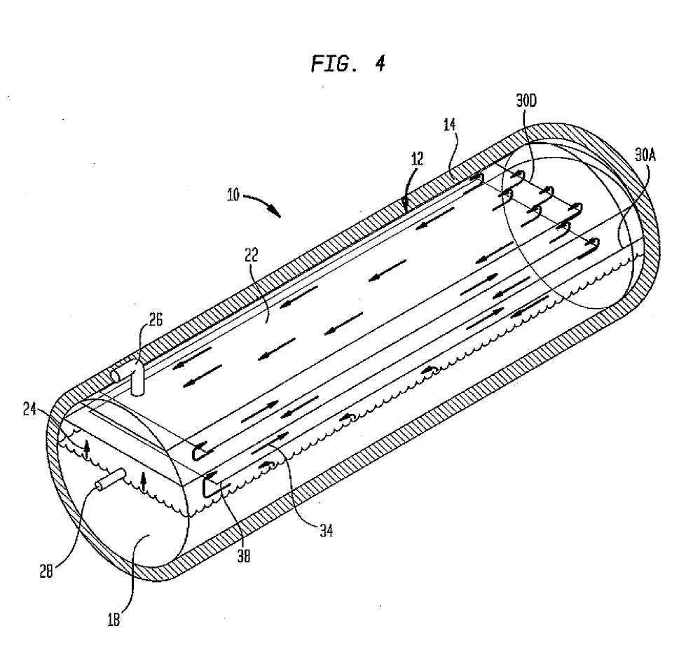

Referring to FIGS. 1 and 3, the plates 30A-30D are arranged in a staggered relationship in the space 16 to provide the passageway 32 as described below. A lowermost one of the plates 30A is connected at three of its sides to an inner surface 36 of the tank 12, while one side 38 of said plate 30A extends toward but does not contact the opposed portion of the inner surface 36 of the tank 12, as shown in FIGS. 1 and 4. An opening 40 is provided between the side 38 of the plate 30A and the inner surface 36 of the tank 12. The next plate 30B positioned directly above and spaced apart from the lowermost plate 30A has three of its sides attached to the inner surface 36 such that one side 42 is attached to the inner surface 36 at a position above the opening 40, thereby providing entrance to a first portion 44 of the passageway 32. A side 48 of plate 30B extends toward but does not contact the opposed portion of the inner surface 36 of the tank 12 as shown in FIG. 1. This arrangement provides for a space 46 between the side 48 of the plate 30B and the inner surface 36 of the tank 12. The next successive plate upward, 30C, is affixed to the inner surface 36 similar to the plate 30A, and has a side 50 extending to but not contacting the inner surface 36 thereby, providing another opening 52 for the gas flow to continue along the passageway 32. The plate 30D is the uppermost plate in the space 16 and is mounted to the inner surface 36 similar to the plate 30B, the plate 30D having a side 54 extending to but not contacting the inner surface 36, thereby providing an opening 56 through which the gas flow is directed to the vent pipe 26.

Each one of the plates 30A-30D is spaced apart from the plate below it, with the plate 30D, the uppermost plate in the space 16, being spaced apart from the inner surface 36 at the roof of the side wall 14. Each of the plates 30A-30D has its corresponding three sides connected to, such as by welding, the inner surface 36 of the tank 12, while one side of each one of the plates extends through the space 16 of the tank 12, but does not contact the inner surface 36 at an opposed side of the tank 12. The alternating or staggered arrangement of the plates 30A-30D with respect to each other provides for the passageway 32 and the openings 40,46,52,56 to join all the pathways between the plates 30A-30D to form the passageway 32, in which the cryogen vapor has a residence time to reach a desired temperature for use after it is exhausted from the tank at the vent pipe 26.

It will be understood that the embodiments described herein are merely exemplary, and that one skilled in the art may make variations and modifications without departing from the spirit and scope of the invention. All such variations and modifications are intended to be included within the scope of the invention as described and claimed herein. Further, all embodiments disclosed are not necessarily in the alternative, as various embodiments of the invention may be combined to provide the desired result.

What is claimed is:

1. A cryogen cylinder, comprising a tank having a side wall defining a chamber for containing a cryogenic substance in the tank; and a plate assembly mounted in the chamber, the plate assembly constructed and arranged to provide a passageway for vapor from the cryogenic substance to be introduced into the passageway.

2. The cryogen cylinder of claim 1, further comprising an outlet in communication with the passageway and through which the vapor can be exhausted from the chamber.

3. The cryogen cylinder of claim 1, wherein the plate assembly comprises a plurality of plates spaced apart from each other in the chamber.

4. The cryogen cylinder of claim 3, wherein each one of the plurality of plates is mounted to the side wall in an alternating pattern for providing the passageway to continuously extend between adjacent ones of the plates in the chamber.

5. The cryogen cylinder of claim 1, further comprising an inlet extending through the side wall of the tank for introducing the cryogenic substance to the chamber.

6. The cryogen cylinder of claim 1, wherein the cryogenic substance is selected from liquid nitrogen and liquid carbon dioxide.

7. The cryogen cylinder of claim 1, wherein the tank is insulated.

8. The cryogen cylinder of claim 1, wherein the chamber has a volume of 300-1000 litres.

9. The cryogen cylinder of claim 1, wherein the plate assembly is manufacture from stainless steel.

10. The cryogen cylinder of claim 1, wherein the plate assembly is mounted in the chamber above a surface of the cryogenic substance.
